(19) United States
(12) Patent Application Publication
(10) Pub. No.: US 2005/0077691 A1
(43) Pub. Date: Apr. 14, 2005

(54) Suspension structure with internal height sensor assembly

(76) Inventor: Allen L. Witters, Chanhassen, MN (US)

Correspondence Address: SHUMAKER & SIEFFERT, P. A., 8425 SEASONS PARKWAY, SUITE 105, ST. PAUL, MN, 55125, US

(21) Appl. No.: 10/957,909

(22) Filed: Oct. 4, 2004

Related U.S. Application Data
(60) Provisional application No. 60/510,913, filed on Oct. 14, 2003.

(51) Int. Cl. B60G 17/01

(52) U.S. Cl. 280/5.514

(57) ABSTRACT

The invention is directed to a suspension structure that includes an internal height sensor assembly. The height sensor assembly monitors the height of the structure, i.e., the distance between first and second sides of the suspension structure. If the height changes, the height sensor assembly may provide this information to a control circuit so that adjustments to the spring constant of the suspension structure can be made. The height sensor assembly may include a reel assembly attached to a first side of the suspension structure, and a cord wound about the reel assembly and attached to a second side of the suspension structure. Detectable elements on the reel assembly or the cord may facilitate height measurements via a sensor circuit. Alternatively, the height sensor assembly may include a magnetic sensor that detects a position of a magnet which moves in response to winding or unwinding of the cord.

### CROSS-REFERENCE TO RELATED APPLICATIONS

This Application claims the benefit of U.S. Provisional Application No. 60/510,913, filed Oct. 14, 2003, the entire content of which is incorporated herein by reference.

### TECHNICAL FIELD

The invention relates to suspension structures such as shocks, struts and the like, commonly used in suspension systems of motor vehicles, non-motor vehicles and other machines.

### BACKGROUND

A wide variety of motor vehicles commonly use suspension structures. For example, cars, trucks, motor homes, motorcycles, all-terrain vehicles (ATVs), snowmobiles, farm equipment, heavy machinery, and the like, typically use suspension structures between an axle and a frame of the respective vehicle or machine. Suspension structures are also used in non-motored vehicles such rail cars, trailers, and the like. The suspension structures absorb shock during motion of the vehicle or machine, and may also be used to control the relative distance between the axle and the frame of the vehicle or machine. In some cases, the suspension structures can both absorb and dampen shock, e.g., to provide a more stable and comfortable environment for passengers in the vehicle.

Two examples of suspension structures are shocks and struts, although other types of suspension structures also exist. Shocks are generally shock absorbing devices, while struts typically perform both shock absorbing and dampening functions. In any case, the suspension structures define a spring constant between first and second sides of the structure. The spring constant, in turn, defines the relative distance between respective sides of the structure when external force is applied on the structure, such as a force associated with the weight of the vehicle frame. In particular, Hooke's Law relating to spring force provides that:
F=−kd,
where F is the force on the spring, k is the spring constant, and d is the displacement of the spring, i.e., the distance between the first and second sides of the spring. The spring constant may be defined by a mechanical spring, elastomers, or in many cases pressurized fluid inside the suspension structure, such as pressurized air inside an air shock.

Some suspension structures allow for adjustment and control of the spring constant. For example, fluid controlled suspension structures, such as air-shocks, may allow for adjustment of the spring constant by regulating input fluid flow into the suspension structure. In the case of air shocks, the amount of air input to the shock may be increased to increase pressure within the shock and thereby increase the spring constant associated with the shock. Similarly, air may be allowed to escape from an air shock to decrease the spring constant associated with the shock. In this manner, air shocks can be used with some vehicles to provide both load-leveling and active suspension spring functions.

Feedback control systems may be implemented, for example, to control the spring constant of a suspension structure in real-time. For example, a distance or height of an air shock may be determined, and then used to control input air flow into the shock. In some cases, it may be desirable to maintain a relatively constant distance between the first and second sides of the air shock even if external forces on the shock change over time. Alternatively, it may be desirable to purposely adjust the distance between the first and second sides of the air shock, e.g., for different road conditions or different loads.

Conventional control systems for an air shock may include one or more sensors external to the air shock that sense a distance between external reference points such as a distance between a frame and an axle. If the distance between the frame and axle changes, the air pressure within the air shock can be changed to re-adjust the distance between the frame and the axle. In this manner, control systems can be used to adjust the spring constant of a suspension structure in response to changing conditions or changing loads on the structure. Control of the spring constant may be automated for real-time adjustments of the spring constant in response to changing conditions, or may be user-controlled in that a user receives a displayed output of conditions on the suspension structure and selects any desired adjustments.

In one conventional example, an external mechanical linkage between the frame and the axle may be used to facilitate distance measurements between the frame and axle, which are proportional to a distance between first and second sides of the suspension structure. Thus, the measured distances between the frame and axle can be used to define, and possibly regulate, the air pressure or fluid pressure inside the suspension structure. External measuring techniques for control of a suspension structure, however, require external components which can be highly susceptible to corrosion, wear, breakage or malfunction.

### SUMMARY

In general, the invention is directed to a suspension structure that includes an internal height sensor assembly. In other words, the height sensor assembly is positioned inside a compartment of the suspension structure. The height sensor assembly may comprise a spring loaded reel assembly attached to a first side, e.g., a top side, of the suspension structure, and a cord wound about the reel assembly and attached to a second side, e.g., a bottom side, of the suspension structure. The height sensor assembly monitors the height of the suspension structure, i.e., the distance between first and second sides of the structure. If the height changes, the height sensor assembly may provide this information to a control circuit so that adjustments to the spring constant of the suspension structure can be made, e.g., automatically or in response to user-selected adjustments.

The suspension structure may form a shock, strut, or similar device. In any case, the internal height sensor assembly can provide information to facilitate control of the spring constant of the suspension structure, e.g., allowing for adjustment of the spring constant in response to changing conditions or loads on the suspension structure. Because the height sensor assembly is internal to the compartment of the suspension structure, problems with corrosion, wear or malfunction can be reduced.

Moreover, installation of the suspension structure can be greatly simplified, e.g., by eliminating the need for height monitoring devices that are external to the suspension structure. If desired, the same design of a height sensor assembly may be used for a wide variety of suspension structures so that economies of scale in production can be exploited. In other words, similar height sensor assemblies may be used in different suspension structures of varying shapes, sizes, and designs.

In one embodiment, the invention provides an apparatus comprising a compartment, a cord within the compartment, a reel assembly that winds the cord as the height of the compartment decreases, and unwinds the cord as the height of the compartment increases, and a sensor circuit that senses winding and unwinding of the cord to determine a height of the compartment. The reel assembly may be spring loaded such that the cord winds about the reel assembly when the suspension structure is compressed, and unwinds from the reel assembly when the suspension structure expands. The reel assembly may include an encoder wheel having detectable elements sensed by the sensor circuit, or alternatively, the detectable elements may be positioned on the cord.

In another embodiment, the invention provides a suspension structure for a vehicle comprising a compartment including first and second sides that can move relative to one another, and means for determining a distance between the first and second sides, the means being housed within the compartment. The means may include a reel and cord configuration in which the reel includes detectable elements that are sensed by a sensor circuit upon rotation of the reel.

In another embodiment, the invention provides a system including a suspension structure comprising a compartment, a cord within the compartment, a reel assembly that winds the cord as the height of the compartment decreases, and unwinds the cord as the height of the compartment increases, and a sensor circuit that senses winding and unwinding of the cord to determine a height of the compartment. The system may also include a control circuit that controls a spring constant of the suspension structure based on output of the sensor circuit.

In another embodiment a system includes a suspension structure comprising a compartment, a cord within the compartment, a reel assembly that winds the cord as the height of the compartment decreases, and unwinds the cord as the height of the compartment increases, and a sensor circuit that senses winding and unwinding of the cord to determine a height of the compartment. The system may also include a control circuit that displays values indicative of output of the sensor circuit, e.g., so a user can make informed decisions regarding potential adjustments to the suspension structure.

In another embodiment, the invention provides a vehicle comprising a vehicle frame, and an axle mechanically connected to the vehicle frame via one or more suspension structures. At least one of the suspension structures may include a compartment, a cord within the compartment, a reel assembly that winds the cord as the height of the compartment decreases, and unwinds the cord as the height of the compartment increases, and a sensor circuit that senses winding and unwinding of the cord to determine a height of the compartment.

In another embodiment, the invention provides a method comprising internally determining a distance between a first side of a suspension structure and a second side of a suspension structure by sensing winding and unwinding of a cord about a reel assembly, and adjusting a spring constant associated with the suspension structure based on the determined distance. The adjustment of the spring constant may be made automatically, or according to user input.

In another embodiment, the invention provides an apparatus comprising a compartment, a cord within the compartment a reel assembly that winds the cord as the height of the compartment decreases, and unwinds the cord as the height of the compartment increases, wherein the real assembly includes a magnet and threading, the threading engaging another threading such that the magnet of the reel assembly moves laterally as the cord winds or unwinds, and a sensor circuit that senses positioning of the magnet to determine a height of the compartment.

In another embodiment, the invention provides a suspension structure comprising a compartment defining a sprung side and an non-sprung side, a cord within the compartment, a reel assembly attached to the sprung side of the compartment that winds the cord as the height of the compartment decreases, and unwinds the cord as the height of the compartment increases, and a sensor circuit that determines a height of the compartment based on the winding and unwinding of the cord.

In another embodiment, the invention provides a method comprising internally determining a distance between a first side of a suspension structure and a second side of a suspension structure by sensing lateral motion of a magnet caused by winding and unwinding of a cord about a reel assembly, and adjusting a spring constant associated with the suspension structure based on the determined distance.

In another embodiment, the invention provides a suspension structure comprising a compartment, a cord within the compartment, a reel assembly including a magnet, the reel assembly being attached to the suspension structure inside the compartment to wind the cord as the height of the compartment decreases, and unwind the cord as the height of the compartment increases, wherein winding and unwinding of the cord causes reel assembly to move about a threading and thereby cause movement of the magnet, and a sensor circuit that determines a height of the compartment based on a position of the magnet

The invention may be capable of achieving a number of advantages. For example, an internal height sensor assembly may reduce the likelihood of corrosion, wear or malfunction associated with external sensors. Moreover, installation of the suspension structure can be greatly simplified with the elimination of height monitoring devices that are external to the suspension structure. In other words, the suspension structure can be assembled with an internal height senor assembly, and then installed without the need to mechanically couple external measuring devices to a vehicle frame.

Also, the internal height sensor assembly may be made compatible with existing vehicle control circuits so that installation simply requires a wired or wireless communication interface between the sensor circuit of the height sensor assembly and a vehicle control circuit. In addition, the internal height sensor assembly may be used in a variety of different suspension structures of varying shapes and sizes without the need to redesign the assembly for use in different suspension structures.

By attaching the height sensor assembly to a sprung side of the compartment, motion of the height sensor assembly can be reduced and damage to the height sensor assembly caused by such motion may be minimized. Also, magnetic sensing techniques using Hall-effect sensors described herein, can also provide for simplified height sensing and mechanical memory. In other words, the position of a magnet relative to a magnetic sensor can define the height of a suspension structure irrespective of past movement of the suspension structure.

Additional details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a cross-sectional side view of a suspension structure in the form of an air shock according to an embodiment of the invention.

FIG. 2 is a side view of an encoder wheel, a cord and a sensor circuit forming part of an internal height sensor according to an embodiment of the invention.

FIG. 3 is an exemplary cross sectional top view of a height sensor assembly according to an embodiment of the invention.

FIG. 4 is another exemplary cross-sectional top view of a height sensor assembly according to an embodiment of the invention.

FIG. 5 is a cross-sectional side view a portion of height sensor assembly similar to that of FIG. 3.

FIG. 6 is a functional block diagram of a sensor circuit coupled to a control circuit according to an embodiment of the invention.

FIG. 7 is a flow diagram illustrating a technique according to an embodiment of the invention.

FIG. 8 is another cross-sectional side view of a suspension structure in the form of air shock.

FIGS. 9 and 10 are conceptual perspective views illustrating two conceptual configurations of reel assemblies that could be used in height sensor assemblies according to embodiments of the invention.

FIG. 11 is an exemplary cross sectional top view of another height sensor assembly according to an embodiment of the invention.

### DETAILED DESCRIPTION

The invention is generally directed to a suspension structure that includes an internal height sensor assembly. In other words, a height sensor assembly is positioned inside a compartment of a suspension structure. The height sensor assembly may comprise a spring loaded reel assembly attached to a first side, e.g., a top side, of the suspension structure, and a cord wound about the reel assembly and attached to a second side, e.g., a bottom side, of the suspension structure. The reel assembly may include detectable elements that are sensed by a sensor circuit to detect travel of the cord within the suspension structure as the cord extends and retracts relative to the reel assembly. The sensed elements may reside on an encoder wheel that rotates with the reel assembly, and may take the form of magnetically, optically, or mechanically detectable elements. Alternatively, the sensed elements may be carried on the cord itself or on a shaft that supports the wheel, and similarly may take the form of magnetically, optically, or mechanically detectable elements. As the height of the suspension structure changes, i.e., the distance between the first and second sides, the reel assembly winds or unwinds the cord under a spring force that biases the reel to wind the cord. Thus, by sensing the detectable elements, e.g., on the reel assembly or the cord, changes in the length of the cord, and hence the height of the suspension structure, can be measured inside the compartment.

The suspension structure may form a shock, strut, or similar device. In the following description, many details of the invention will be provided with reference to an air shock. The same concepts, however, may be readily applied to other suspension structures, including shocks or struts having pressurized fluid to define the spring constant, or possibly other types of shocks or struts that include adjustable mechanical springs, elastomers, or the like. Also, suspension structures other than shocks or struts may incorporate an internal height sensor assembly consistent with the disclosure provided herein.

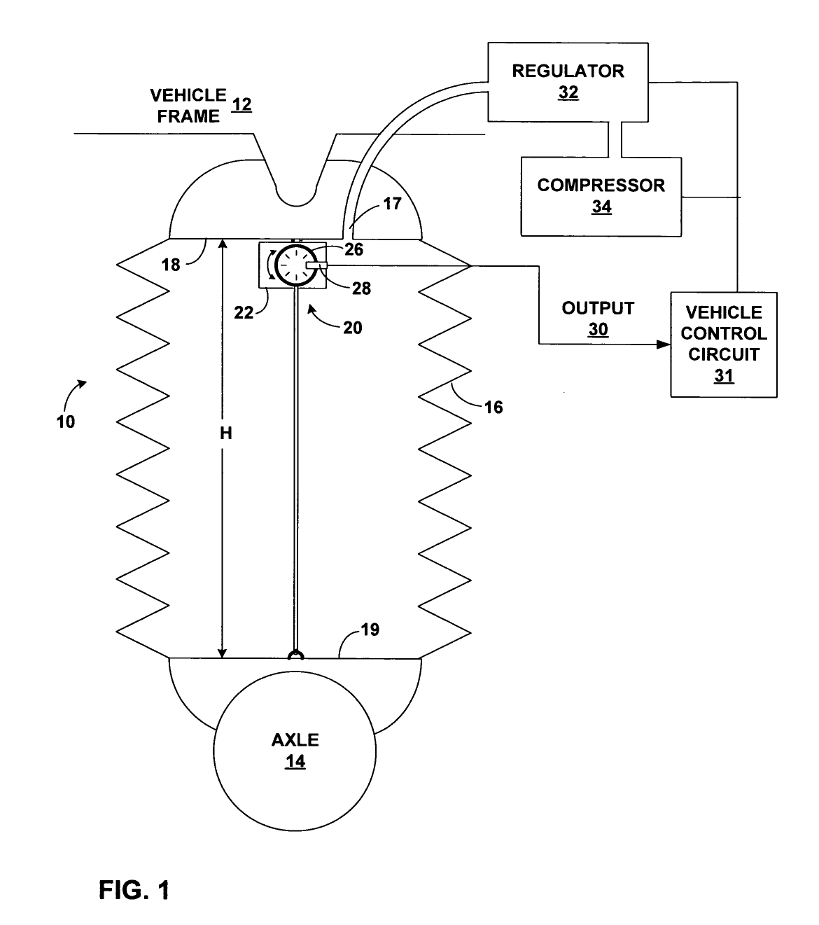

FIG. 1 is a cross-sectional side view of a suspension structure in the form of air shock 10. Air shock 10 is shown attached to a vehicle, i.e., attached to frame 12 and axle 14 of the vehicle. The vehicle may include wheels mechanically coupled to the axle, and an engine that causes movement of the wheels. The vehicle may comprise a car, truck, semi-truck, motor home, motorcycle, all-terrain vehicle (ATV), snowmobile, farm equipment, or the like. Moreover, numerous other applications of air shock 10, or similar suspension structures, also exist, including applications in heavy machinery, non-motored vehicles, rail cars, trailers, and the like.

Air shock 10 includes an air input 17 that facilitates the introduction and removal of air from compartment 16 of air shock 10. An increase in air pressure within compartment 16 increases the spring constant, whereas a decrease in air pressure reduces the spring constant. Thus, if air shock 10 needs to be more rigid, e.g., in response to an increased load on vehicle frame, or in response to a specific terrain, then more air can be introduced into compartment 16. Similarly, if air shock 10 needs to be less rigid, then air can be removed from compartment 16 to reduce its spring constant.

Given a specific load on air shock 10, the spring constant associated with air shock is generally proportional to height (H). Height (H) refers to the distance between a first side 18 of compartment 16 and a second side 19 of compartment 16, and may change because first side 18 can move relative to second side 19. If the amount of fluid within compartment 16 is held constant, changes in height (H) are generally caused by changes in the load on vehicle frame 12, or vertical movement of frame 12 relative to axle 14 caused by the terrain. For example, as the vehicle drives over bumpy terrain, air shock 10 absorbs the bumps to reduce movement of vehicle frame 14. The absorption of bumps causes changes in height (H) as air shock 10 compresses and expands. Air shock 10 may also be used to allow for load balancing across different tires of a vehicle. In other words, different air shocks of a vehicle may assume different spring constants to achieve load balancing.

In accordance with the invention, air shock 10 may include an internal height sensor assembly 20. Height sensor assembly 20 is internal in that it is enclosed within compartment 16 of air shock 10. Accordingly, height sensor assembly 20 is substantially protected from the environment after assembly of air shock 10. Moreover, air shock 10 including height sensor assembly 20 can be installed in a vehicle with ease, generally avoiding the need to mechanically mount external height sensor hardware to vehicle frame 12 or axle 14. Internal height sensor assembly 20 may be capable of measuring an average height even if unpredictable or non-uniform movement of the first side 18 relative to second side 19 occurs.

Internal height sensor assembly 20 may comprise a reel assembly 22 attached to first side 18 of compartment 16, and a cord 24 having a first end coupled to a shaft associated with reel assembly 22. A second end of cord 24 is attached to second side 19 of compartment 16. Reel assembly 22 may comprise a spring loaded shaft (not seen in FIG. 1) about which cord 24 is wound. The spring may be biased to wind cord 24 about the shaft in the absence of opposing force. An encoder wheel 26 rotates with the spring loaded shaft. Encoder wheel 26 includes detectable elements such as optically detectable markings, magnetic elements, slits, holes, mechanical surfaces, or the like, that facilitate measurements of the angular motion of the spring loaded shaft by sensor circuit 28. Given a known radius of the spring loaded shaft and measured angular motion, linear distance changes in height (H) can be determined. The various components of reel assembly 22 may be detachable from one another, or some or all of the components may be integrally formed to define substantially continuous structure(s).

A sensor circuit 28 generates an output 30 indicative of changes in height (H) and sends output 30 to vehicle control circuit 31, e.g., in the form of a wired or wireless signals. Vehicle control circuit 31, in turn, may control a regulator 32 to adjust or define the spring constant of air shock 10. For example, a compressor 34 provides compressed air to regulator 32, which regulates input air flow into compartment 16 and output air flow from compartment 16. Output 30 provides the information needed to make decisions about the regulation of air flow into compartment 16. In some cases, output 30 may cause vehicle control circuit 31 to make automatic adjustments to regulator 32. In addition, output 30 may be presented to a user via a display screen driven by control circuit 31. In the latter case, the user can make informed decisions regarding manual adjustment of the spring constant of air shock 10.

In this manner, measurements from internal height sensor assembly 20 can facilitate presentation of variables associated with the spring constant of air shock 10 to a user, and possibly permit manual adjustment of the spring constant in response to changing conditions. In other configurations, output 30 may be sent directly to compressor 34 or regulator 32, which may provide direct regulation of air input or output from compartment 16 on an automated basis. Providing output 30 to vehicle control system 31, however, may provide advantages in terms of backwards compatibility with existing vehicle control circuits or systems. In that case, output 30 can be made to conform to the protocol used by an existing vehicle circuit so that redesign of the vehicle control circuit can be avoided.

Another advantage of height sensor assembly 20 is that it may be used in a variety of different suspension structures, e.g., air shocks of different shapes and sizes than air shock 10, or other suspension structures, such as struts. Thus, the need to redesign height sensor assembly 20 for use in the different suspension structures can be avoided. Instead, substantially the same design of a height sensor assembly may be standardized for a variety of different suspension structures, so that economies of scale in production can be exploited.

Also, height sensor assembly 20 is advantageous in that it is attached to first side 18. First side 18 refers to the “sprung side,” of air shock 10 and generally moves much less than second side 19, i.e., the “non-sprung side.” In other words, first side 18 is closer to vehicle frame 12 whereas second side 18 is closer to axel 14 which moves. Movement of axle 14 causes movement of side 19 but does not cause substantial movement of side 18. For this reason, it is advantageous to a height sensor assembly 20 on first side 18.

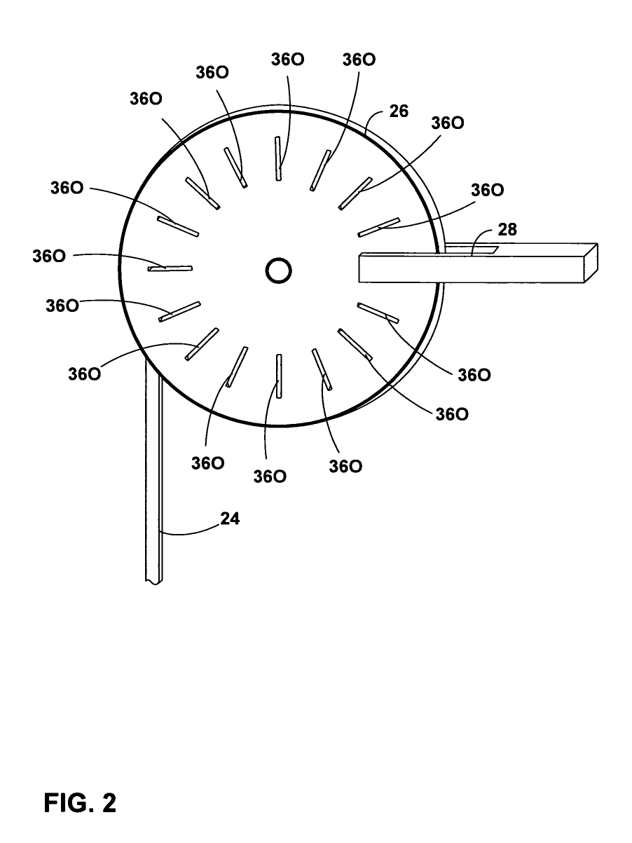

FIG. 2 is a side view of encoder wheel 26, cord 24 and sensor circuit 28. Again, cord 24 is wound about a spring loaded shaft (not shown in FIG. 2) that rotates with encoder wheel 26. In the example of FIG. 2, encoder wheel 26 includes detectable elements 36A-360 in the form of slits (collectively elements 36) positioned at radial locations about a circumference of the encoder wheel 26. If elements 36 take the form of slits as shown in FIG. 2, each of elements 36 may extend through encoder wheel 26. Sensor circuit 28 detects rotation of encoder wheel 26 by detecting the motion of detectable elements 36.

As mentioned, in the example illustrated in FIG. 2, detectable elements 36 comprise slits that extend through encoder wheel 26. In that case, sensor circuit 28 may include one or more electromagnetic radiation sources, such as one or more light sources positioned on a first side of encoder wheel 26 to send light through detectable elements 36. One or more electromagnetic radiation detectors, such as photodetectors, may be positioned on an opposing side of encoder wheel 26 to detect light through detectable elements 36 with the rotation of encoder wheel 26. In particular, as seen by the photodetectors, light may switch on and off, depending on the location of detectable elements 36 relative to the light source and photodetectors. The use of two or more photodetectors can enable determination of the direction of rotation of encoder wheel 26, e.g., based on which photodetector is the first to detect light through a given element 36. Also, two or more photodetectors can allow for the use of coding techniques that can achieve improved resolution of height measurements.

In another example, the detectable elements on an encoder wheel may comprise machine readable markings that can be detected based on reflected light can be used to determine the presence of given marking at any given time. In that case, the sensor circuit may include one or more electromagnetic radiation sources, such as one or more light emitting diodes positioned on a first side of the encoder wheel to illuminate the detectable elements. Moreover, one or more electromagnetic radiation detectors, such as photodetectors, may be positioned on the same side of the encoder wheel to detect light reflected by the elements with the rotation of the encoder wheel. Again, the use of two or more photodetectors can enable determination of the direction of rotation of the encoder wheel, e.g., based on which photodetector is the first to detect light reflected by a given detectable element.

In still other examples, the detectable elements may comprise magnetic changes that are magnetically detectable, e.g., by a magnetic head. In that case, the sensor circuit may include one or more magnetic heads positioned to detect the magnetic changes. Also, the detectable elements may comprise mechanical changes that can be detected by contact to a sensor circuit.

In other examples, the detectable elements may reside on cord 24 rather than encoder wheel 26. In that case, the need for an encoder wheel may be eliminated, and the cord can be wound about a shaft, with the sensor circuit positioned to detect movement of elements on the cord. These and a number of other configurations could be used in accordance with the invention.

The number of detectable elements 36 located about the circumference of encoder wheel 26 (or on the cord) may define a resolution of height sensor assembly 20 (FIG. 1). In particular, a radius of the shaft used to wind cord, and the number of detectable elements 36 may define the linear resolution associated with distance measurements of changes in height (H). Detection of rotation of encoder wheel 26 may be quantified by identifying the passing of two adjacent elements, e.g., elements 36A and 36B, moving past sensor circuit 28. The radial distance between two elements may define a degree of linear movement of cord 24 according to the equation:
ΔH=2ΠR(r),
where ΔH defines the linear change in the distance between first side 18 and second side 19 of compartment 16 (see FIG. 1), R defines a radius of the shaft that winds cord 24, and r defines the change in angular motion in radians. In accordance with the invention, any number of detectable elements 36 may be formed on encoder wheel 26 to define a desired resolution. Moreover, quadrature coding techniques using the output of more than one photo detector may allow for additional resolution of the angular measurements as outlined in greater detail below. If the detectable elements reside on cord 24, the need to calculate a linear distance from an angular distance measurement, however, may be avoided.

In one example, encoder wheel 26 includes approximately sixty-five slits located at radial locations about the circumference of encoder wheel 26, with neighboring slits being separated by a common radial distance. The radius (R) of the shaft that winds cord 24 may be approximately one centimeter, although the invention is not limited in that respect. Such sizes, with additional quadrature coding as outlined below, can achieve resolution of height measurements of less than 0.038 cm±0.013 cm.

Cord 24 may comprise any substantially flexible but non-stretchable string, thread, filament, twine, rope, wire, line, cable, or the like. In one example, a high-test fishing line may be used to realize cord 24. Many other elongate and flexible, yet substantially non-stretchable materials could also be used to realize cord 24. In particular, cord 24 may be substantially non-stretchable along the longitudinal axis of cord 24 to ensure that stretching does not undermine precise height measurements. Cord 24 may include a single filament, or multiple filaments, if desired.

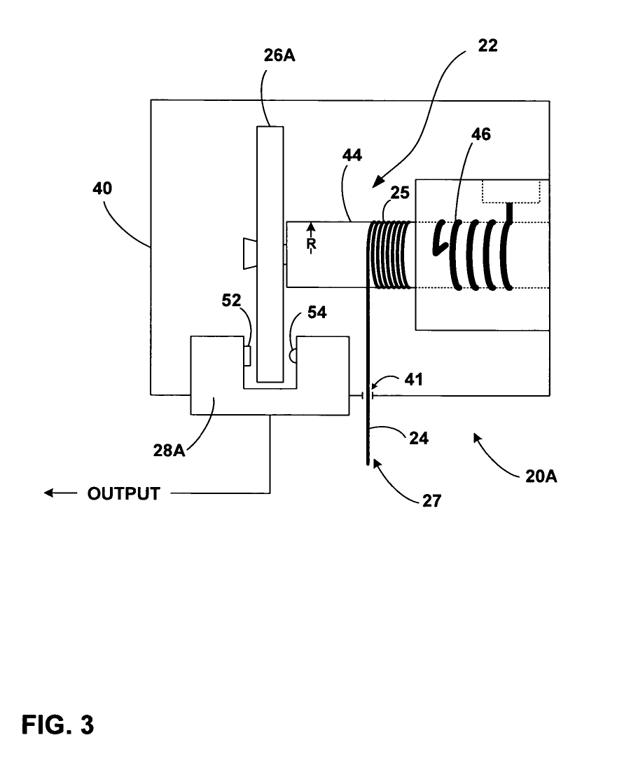

FIG. 3 is an exemplary cross sectional top view of a height sensor assembly 20A according to an embodiment of the invention. Height sensor assembly 20A can be housed internally inside a compartment of a suspension structure similar to height sensor assembly 20 illustrated in FIG. 1. As shown in FIG. 3, height sensor assembly 20A comprises a reel assembly 22 that can be attached to a first side of a compartment of a suspension structure. Reel assembly 22 may be housed inside a reel assembly housing 40 to facilitate simplified attachment inside the suspension structure and mechanical protection prior to assembly inside the suspension structure. Height sensor assembly 20A also includes a cord 24 having a first end 25 wound about reel assembly 22. A second end 27 of cord 24 passes through a hole 41 in reel assembly housing 40, and can be attached to a second side of the internal compartment of the suspension structure. Mounting hardware may be added to the second side of the suspension structure to simplify attachment of reel assembly housing, if desired.

Reel assembly 22 may comprise a spring loaded shaft 44 about which cord 24 is wound. In particular, shaft 44 may be mechanically coupled to a coiled torsion spring 46 to provide a constant and substantially continuous rotational torque on shaft 44, thereby exerting a retracting force on cord 24. Numerous other spring loaded configurations, however, could also be used in accordance with the invention. Shaft 44 and other components of reel assembly 22 may be lubricated to reduce frictional effects, and various bearings, or the like may also be added for similar purposes. Coiled torsion spring 46 may define a substantially constant torque on shaft 44, and may also provide dampening effects, if desired, to reduce the likelihood of improper winding or cord 24. Coiled torsion spring 46 defines a retraction force of shaft 44 that serves to wind cord 24 when the distance between the top and bottom of the suspension structure is reduced, e.g., under a load, or unwind cord 24 when the distance is increase, e.g., upon reducing the load.

Encoder wheel 26A rotates with the spring loaded shaft 44. Encoder wheel 26A includes detectable elements such as slits, holes, machine readable marks, magnetic elements, mechanical surface variations, or the like that facilitate measurements of the angular motion of the spring loaded shaft 44 by sensor circuit 28A. Again, given a known radius (R) of the spring loaded shaft 44 and measured angular motion (r) of encoder wheel 26A, linear distance changes in the height (ΔH) of a suspension structure can be determined internally, i.e., inside the suspension structure. The radius (R) of shaft 44 may be approximately one centimeter, although the invention is not limited in that respect.

In the configuration illustrated in FIG. 3, sensor circuit 28A is transmissive, in that one or more a light sources 52 are positioned on a first side of encoder wheel 26A and one or more photodetectors 54 are positioned on a second side of encoder wheel 26A. In that case, the detectable elements on encoder wheel 26A comprise slits, holes, or the like, such that light from light source(s) 52 passes through the detectable elements on encoder wheel 26A for detection by photodetector(s) 54 in order to determine angular motion of encoder wheel 26A.

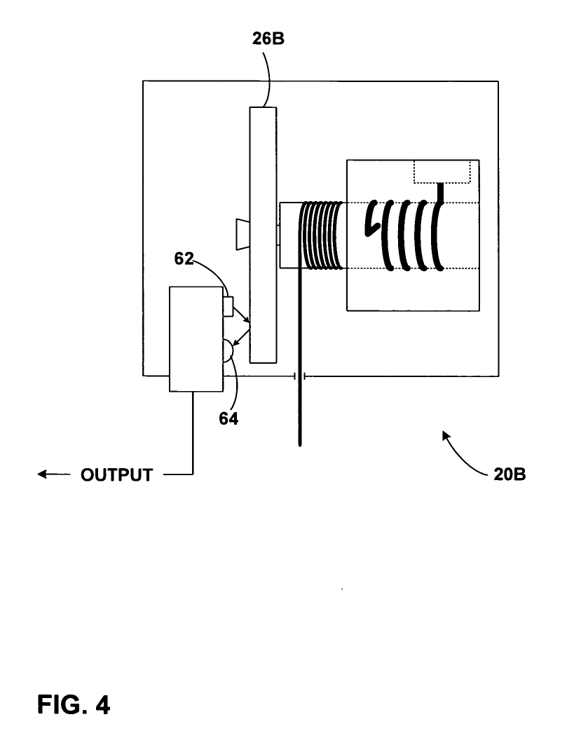

FIG. 4 is another exemplary cross-sectional top view of a height sensor assembly 20B according to an embodiment of the invention. In particular, FIG. 4 illustrates a height sensor assembly 20B that uses reflective techniques rather than transmissive techniques. Height sensor assembly 20B may be substantially similar to height sensor assembly 20A of FIG. 3, except that one or more light sources 62 and one or more photodetectors 64 are positioned on a common side of encoder wheel 26B. In FIG. 4, the detectable elements on encoder wheel 26B comprise machine readable reflective markings. In other words, reflective characteristics of the markings may be different than the reflective characteristics of the regions between markings, e.g., a white wheel 26B with black markings, or a black wheel 26B with white markings. Light from light source(s) 62 reflects off the detectable elements in the form of reflective markings on encoder wheel 26 for detection by photodetector(s) 64. The reflective markings may operate similarly to a bar code in that the markings may reflect or absorb light in a manner that is different from areas between respective markings.

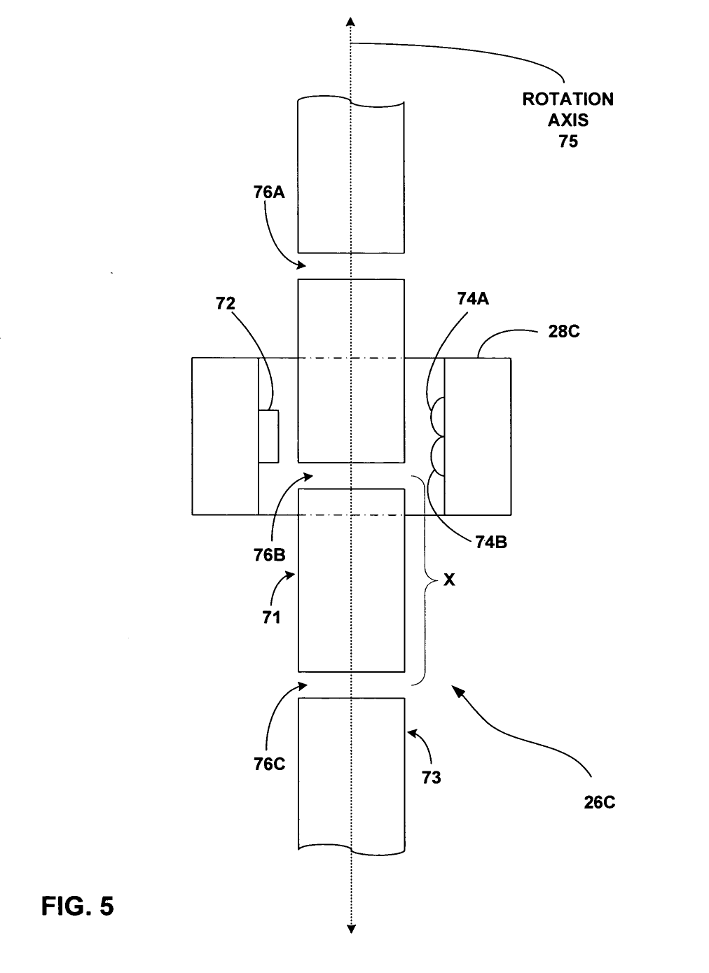

FIG. 5 is a cross-sectional side view a portion of a height sensor assembly similar to that of FIG. 3 in that the encoder wheel 26C includes detectable elements that are transmissive such as slits, holes, or the like. In particular, FIG. 5 illustrates sensor circuit 28C relative to encoder wheel 26C. Sensor circuit 28C includes a light source 72 on a first side 71 of encoder wheel 26C, and two or more photodetectors 74A, 74B on a second side 73 of encoder wheel 26C, i.e., the second side 73 being opposite the first side 71. Rotational axis 75 illustrates potential motion of encoder wheel 26C in two possible angular directions relative to sensor circuit 28C.

Light source 72 may comprise a light emitting diode (LED), although any type of light source could be used. A semiconductor light source such as an LED, however, provides advantages in terms of longevity, which is important in an internal height sensor design because replacement of a light source would typically require disassembly of the suspension structure.

Light from light source 72 can pass through one of slits 76A-76C for detection by photodetectors 74A, 74B. The directional angular motion of encoder wheel 26C can be determined by sensor circuit 28C by identifying which photodetector 74A or 74B first detects the light. For example, if light is first detected by photodetector 74A, and then 74B, then motion of encoder wheel 26C would be in a first direction. Alternatively, if light is first detected by photodetector 74B, and then 74A, then motion of encoder wheel 26C would be in a second direction.

In general, sensor circuit 28C may identify angular motion in the amount of an angular distance (X), upon first identifying light being detected by photodetector 74A, then 74B, then a period of no light being detected, followed by subsequent detection by photodetector 74A. Likewise, sensor circuit 28C identifies angular motion in the amount of an angular distance −X, upon first identifying light being detected by photodetector 74B, then 74A, then a period of no light being detected, followed by subsequent detection by photodetector 74B. Quadrature coding techniques, however, may be used to improve the resolution beyond measurements in units of distance X, as outlined in greater detail below.

Upon identifying an angular distance, the angular distance can be converted to a height change of the suspension structure, e.g., a linear distance change of the length of cord 24 unwound from the shaft. In particular, as mentioned above, sensor circuit 28C may invoke the equation:
ΔH=2ΠR(r),
where ΔH defines the linear change in the distance between first side 18 and second side 19 of compartment 16, and R defines a radius of the shaft that winds cord 24, and r defines angular motion in radians (see FIG. 1). Importantly, the use of two or more photodetectors 74A, 74B (FIG. 5) can provide the ability to identify the direction of the angular motion of encoder wheel 26C.

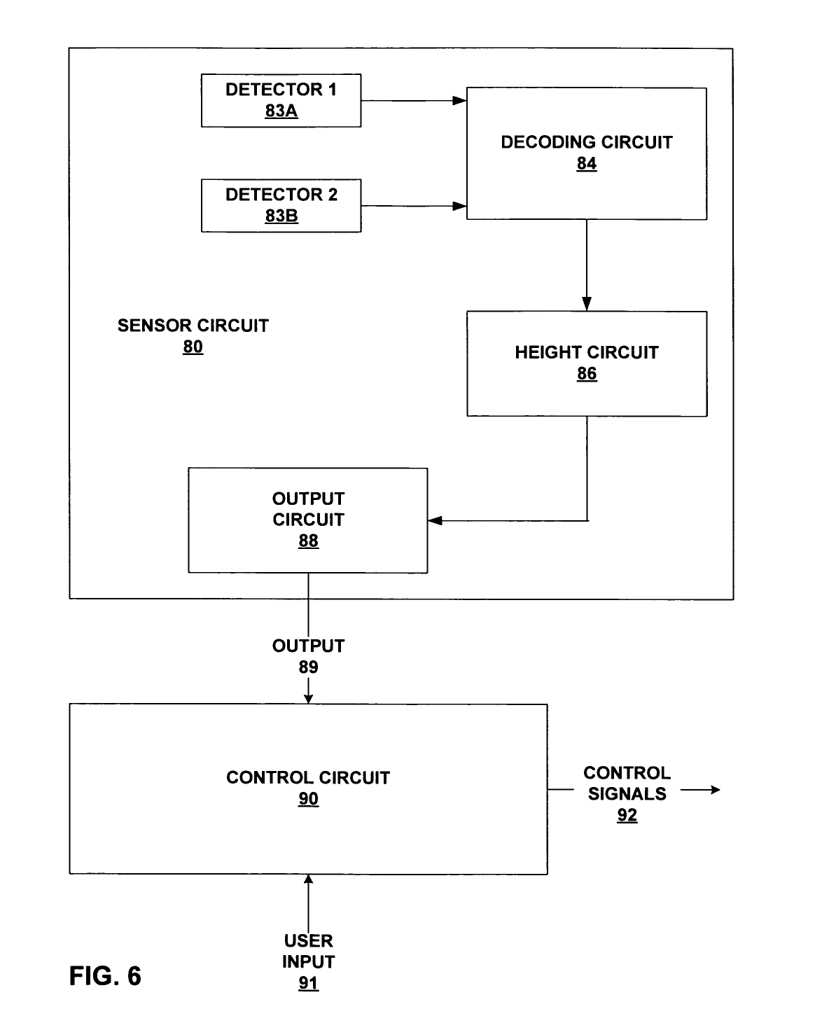

FIG. 6 is a functional block diagram of a sensor circuit 80 coupled to a control circuit 90. Sensor circuit 80 may correspond to any of sensor circuits 28, 28A, 28B or 28C described above. Sensor circuit 80 includes first and second detectors 83A, 83B that detect detectable elements, e.g., in either a transmissive or reflective scenario. Decoder circuit 84 receives signals from detectors 83A, 83B and determines an amount and direction of angular motion of the encoder wheel (or linear motion of the cord if the detectable elements are formed on the cord). Detectors 83A, 83B and decoding circuit 84 may also employ quadrature-coding techniques to improve the resolution and accuracy of measured angular motion of the encoder wheel.

If quadrature-coding techniques are used, sensor circuit 80 is capable of identifying four separate positions between any two adjacent detectable elements. Quadrature-coding takes further advantage of the presence of two separate detectors 83A and 83B. The two detectors 83A, 83B provide substantially the same information, i.e., electrical pulses, but the pulses from detectors 83A, 83B can have phase shifts of ninety degrees between each other. This phase shift is referred to as quadrature-coding as known in the art of optical signal processing. Output of detectors 83A, 83B may take the form of a frequency, but the pulse rate is dependent on rotational velocity of the encoder wheel. Since the two channels associated with detectors 83A, 83B are phase shifted by ninety degrees, there are four possible states per cycle between adjacent optical elements. Also, detected pulses can be divided by units of time to determine the angular velocity of the encoder wheel. Thus, decoder circuit 84 may determine both angular motion and angular velocity of the encoder wheel, which can be useful in determining a desired spring constant of the suspension structure.

Height circuit 86 receives calculated angular motion of an encoder wheel from decoding circuit, and possibly calculated angular velocity. Height circuit 86 converts the angular values to linear values indicative of the height change of the suspension structure, and possibly the linear time rate of change in height of the suspension structure. In particular, height circuit may apply the equation:
ΔH=2ΠR(r),
to define the linear change in height, where ΔH defines the linear change height, and R defines a radius of the shaft that winds cord 24, and r defines the calculated angular motion in radians. If the detectable elements are on the cord, however, the need to convert from measured angular distance to a linear distance may be avoided because the linear motion of the cord could be sensed directly. Still the configuration in which the detectable elements are on an encoder wheel may provide advantages in terms of manufacturing simplicity, simplified installation, and other advantages.

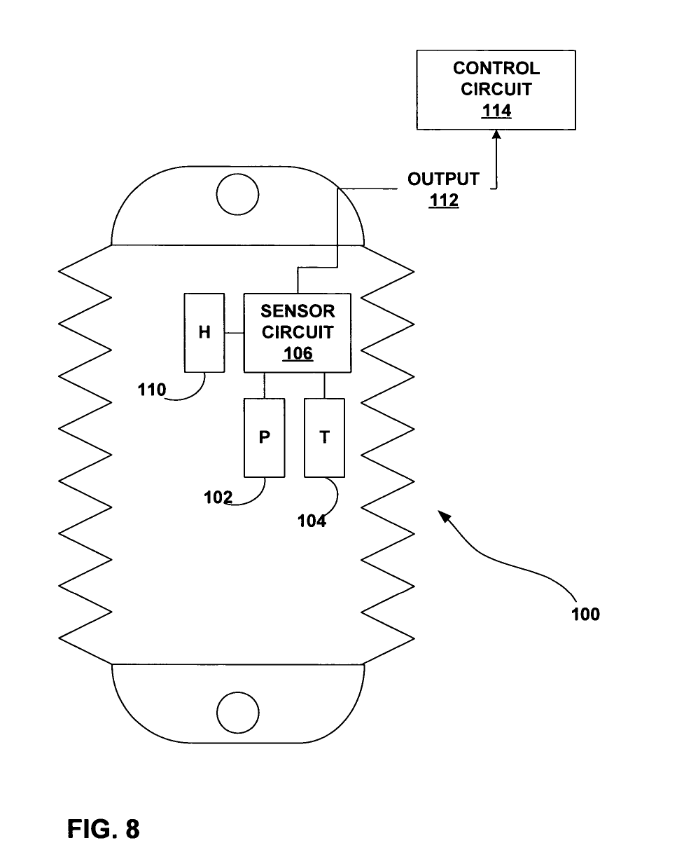

Output circuit 88 receives the calculated linear distance, and possibly a calculated linear velocity from height circuit 86, and generates output 89 which is typically a digital machine instruction defining output according to a defined protocol. Output 89 may be sent directly to control circuit 90, or may be stored until requested by control circuit 90. In some cases, sensor circuit 80 may further include pressure and temperature sensors in addition to height sensors, as outlined in greater detail below with reference to FIG. 8. In that case, output circuit 88 may receive measured values for temperature and pressure in addition to height measurements. Accordingly, output 89 may also include this pressure and temperature information.

Control circuit 90 may comprise a universal control system for a vehicle or machine, or may be a more specific control circuit designed to control parameters of a suspension structure. In any case, control circuit 90 may control or define the parameters of the suspension structure, such as the spring constant, in response to output 89 received from sensor circuit 80. In one example, control circuit 90 may make automatic adjustments to the suspension structure based on output 89. Alternatively, control circuit 90 may present output 89 to a user via a display screen (not shown). In the later case, control circuit 90 may receive user input 91 specifying desired changes to the height, spring constant, pressure, temperature or other variables of the suspension structure. Control circuit 90 may send control signals 92, e.g., to a regulator or compressor, to increase or decrease air flow into or out of the suspension structure. Control circuit 90 may comprise a master vehicle control, and sensor circuit 80 may be designed such that output 89 conforms to the protocol used by control circuit 90. In that case, redesign of the vehicle control circuit can be avoided, and simplified installation and compatibility of a suspension having an internal height sensor can be achieved.

In one example, control circuit 90 and sensor circuit 80 operate in a master-slave relationship in which control circuit 90 is the master and sensor circuit 80 is the slave. In that case, control circuit 90 may query sensor circuit 80, and output 89 may be sent in response to the query. In other examples, sensor circuit 80 may output substantially continuous measurements to control circuit 90 for real time response or display by control circuit 90.

Control circuit 90 can use the received information from sensor circuit 80 to either automatically adjust the suspension structure, or to present the requested information to a user, such as via a display. In other words, in some cases, a user may provide input 91 to control circuit 90 for subsequent adjustments to the suspension structure based on displayed output 89, e.g., on a display inside the vehicle, and in other cases, control circuit 90 may make automatic adjustments to the suspension structure directly based on output 89. In either case, control circuit 90 may send one or more control signals 92, e.g., to an air pressure regulator, in order to adjust the pressure, temperature and/or height or the suspension structure. Control circuit 90 may also operate according to a master slave relationship with the air pressure regulator, in which pressure changes to adjust the spring constant occur only when specific control signals 92 are sent. In other words, control circuit 90 may be the master and the circuit of the air pressure regulator may be the slave.

Communication of output 89 and control signals 92 may be accomplished via a wired or wireless connection. In other words, sensor circuit 80 and control circuit 90 may have a wired connection, or may include transmitters and receivers for wireless communication. In one example, output 89 is sent via a wired RS-232 interface, and in another example, output 89 is sent via a controller area network (CAN) protocol. Numerous other wired or wireless protocols could also be used in accordance with the invention. Communication of control signals 92 from control circuit 90, e.g., to a regulator or compressor, may also be wired or wireless.

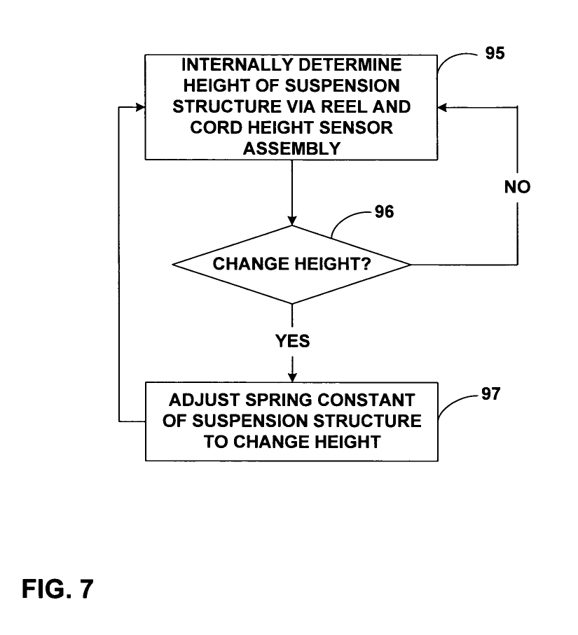

FIG. 7 is a flow diagram illustrating a technique according to an embodiment of the invention. As shown, a height sensor assembly 20 internally determines a height of a suspension structure (95). In particular, height sensor assembly may define a reel-cord configuration with an encoder wheel and a senor circuit as outlined herein. If height changes are detected (yes branch of 96), then the spring constant of the suspension structure may be adjusted to change the height of the suspension structure (97). Again these spring constant adjustments, may be performed automatically, or in response to user input, e.g., by a user changing parameters that affect the spring constant after identifying undesirable characteristics of the suspension structure on a display screen.

FIG. 8 is another cross-sectional side view of a suspension structure in the form of air shock 100. Air shock 100 may be substantially similar to air shock 10 described above, with the addition of one or more pressure sensor(s) 102 and temperature sensor(s) 104. In that case, sensor circuit 106 may output values of height, pressure and temperature to control circuit 108. In some cases, pressure sensor(s) 102, temperature sensor(s) 104 and height sensor (110) may be integrated as a single electrical sensor circuit that can be installed inside the compartment of air shock 100 in a relatively simple fashion. By way of example, pressure sensor(s) 102 may measure pressure within a range of 0 to 1035 kPa, and temperature sensor(s) 104 may sense temperatures within a range of −40 to 200 degrees Celsius.

Temperature sensor 104 may provide voltage output proportional to temperature according to the specification of temperature sensor 104. However, any type temperature sensor could also be used. In any event, temperature information, like the height and pressure information, may be sent as output in the form of machine instruction defined to digitally communicate the measured temperature.

Pressure sensor 102 may comprise a piezo-resistive sensor that measures pressure and outputs voltages proportional to the measured pressure, although many other types of pressure sensors could also be used. The output of the pressure measurements in terms of analog voltage can be converted to digital machine instructions, e.g., by an output circuit of the sensor circuit 106. Output 112 in the form of pressure, temperature and/or height information can be sent to control circuit 114 upon request by control circuit 114, or continuously to control circuit 114 depending on the design.

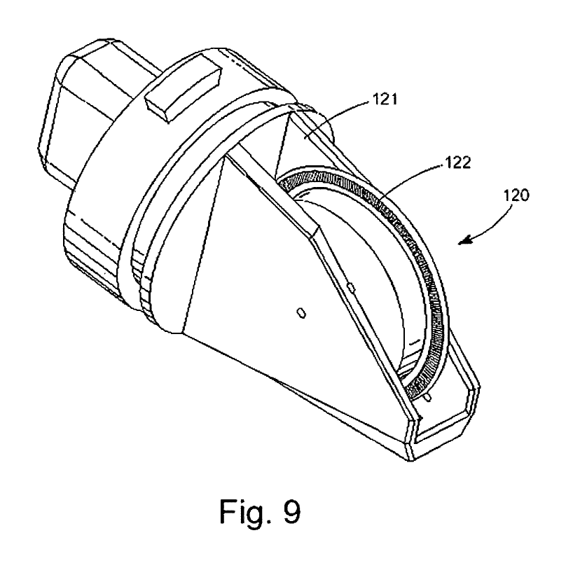

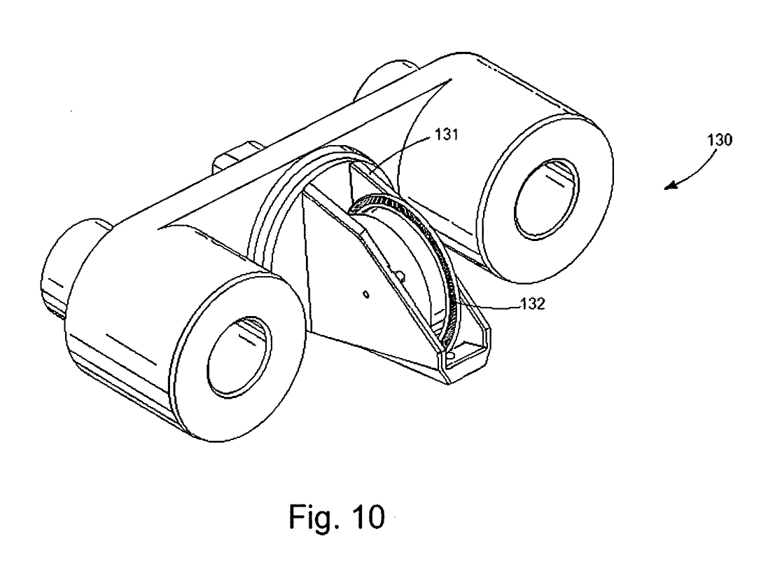

FIGS. 9 and 10 are conceptual perspective views illustrating two conceptual configurations of reel assemblies that could be used in height sensor assemblies according to embodiments of the invention. Each of reel assemblies 120, 130 includes an encoder wheel 122, 132 that rotates about a sensor circuit inside a respective reel structure 121, 131. A cord can be wound about a shaft that rotates with encoder wheel 122, 132. Reel structure 122, 132 can be easily installed inside an air shock by attaching the reel structure 122, 132 to a first side of the air shock and attaching a distal end of the wound cord (not illustrated) to a second side of the air shock.

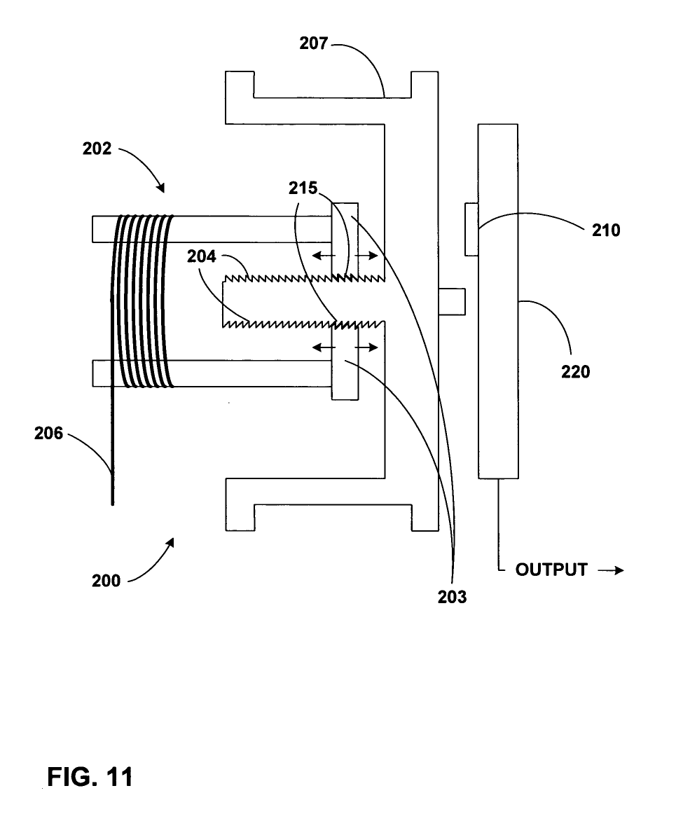

FIG. 11 is an exemplary cross sectional top view of another height sensor assembly 200 according to an embodiment of the invention. Height sensor assembly 200 can be housed internally inside a compartment of a suspension structure similar to height sensor assembly 20 illustrated in FIG. 1. Height sensor assembly 200 may operate in a similar fashion to other height sensor assemblies described herein, in that winding or unwinding of a cord is translated into height measurements.

Height sensor assembly 200, however differs from many of the embodiments described above, in that height sensor assembly 200 makes use of a magnetic sensor 210, such as a Hall-effect sensor, rather than using optical sensing. As shown in FIG. 11, height sensor assembly 200 comprises a reel assembly 202 including threading 215 that that engages threading 204 of structure 207. Reel assembly 202 also includes a magnet 203. Cord 206 is wound about reel assembly 202.

Compression or expansion of the suspension structure causes cord 206 to wind or unwind around reel assembly 202. When this occurs, magnet 203 of reel assembly 202 moves laterally as illustrated by the arrows. In particular, threading 215 of reel assembly 202 threadedly engages threading 204 of structure 207. Rotation of reel assembly 202, e.g., caused by winding or unwinding of cord 206, causes reel assembly 202 to move laterally one way or the other. Threading 215 may be disposed on magnet 203 (as illustrated) or may be formed on another portion of reel assembly 202. In other words, magnet 203 may form a spool about threading 204 or may alternatively be disposed on a spool made of non-magnetic material. In any case, when cord 202 winds about reel assembly 202, magnet 203 of reel assembly 202 is caused to move in one direction, and when cord 202 unwinds from reel assembly 202, magnet 203 of reel assembly 202 is caused to move in the other direction. Movement of magnet 203 is caused by the spooling or unspooling about threading 204. Although not specifically shown in FIG. 11, reel assembly may be spring loaded in order to provide a sufficient bias on cord 206. For example, reel assembly 202 may include a coiled torsion spring (not shown) to provide a constant and substantially continuous rotational torque in order to bias cord 206.

The motion of magnet 203 can be detected by magnetic sensor 210, mounted on a sensor circuit 220, e.g., a circuit board. Output from sensor circuit 220 can be interpreted to define linear expansion or compression of the suspension structure. Output 220 may be wired or wireless. In particular, magnetic sensor 210 may define a voltage, e.g., between 0 and 5 volts, depending on the relative distance of magnet 203 from magnetic sensor 210. Magnet 203 may be rotatable approximately 10 revolutions about threading 204 to define the full range of heights of the suspension structure, although the invention is not limited in that respect. Sensor circuit 220 may digitize the measure voltage to digital values, e.g., between 0 and 1024 or between 0 and 16000 corresponding to the voltage range of 0 to 5 volts. The signals indicative of the distance of magnet 203 from magnetic sensor 210 translate into measurements of the height of a suspension structure that houses height sensor assembly 200, such as a suspension structure similar to air shock 10.

In this manner, height sensor assembly 200 can identify changes in the height of the suspension structure. Height sensor assembly 200 may include various other features described above with reference to discussion of other assemblies that make use of optical sensing. However, height sensor assembly 200 differs from many of the embodiments described above, in that height sensor assembly 200 makes use of a magnetic sensor 210, such as a Hall-effect sensor, rather than using optical sensing. Height sensor assembly 200 has numerous advantages including the realization of purely mechanical memory. In other words, the position of magnet 203 relative to magnetic sensor 210 can define the height of a suspension structure irrespective of past movement. Again, the height refers to the distance between a first side of a compartment and a second side of compartment.

A number of embodiments of the invention have been described. In particular, a height sensor assembly has been described for installation internally to a suspension structure. The described embodiments and many other embodiments are within the scope of the following claims. For example, while examples of magnetic and optical sensing have been described, other types of distance converters or measurement devices may also be used. These and other embodiments are within the scope of the following claims.

1. An apparatus comprising:
a compartment;
a cord within the compartment;
a reel assembly that winds the cord as the height of the compartment decreases, and unwinds the cord as the height of the compartment increases; and
a sensor circuit that senses winding and unwinding of the cord to determine a height of the compartment.

2. The apparatus of claim 1, wherein the apparatus forms a suspension structure for a vehicle.

3. The apparatus of claim 1, wherein the reel assembly includes a spring-loaded shaft to wind the cord, and an encoder wheel that rotates with the shaft, the encoder wheel including detectable elements that are sensed by the sensor circuit.

4. The apparatus of claim 3, wherein the reel assembly further includes a reel assembly housing to house the spring-loaded shaft and encoder wheel, the reel assembly housing defining a hole through which the cord passes.

5. The apparatus of claim 3, wherein the detectable elements comprise slits positioned at radial locations about a circumference of the encoder wheel.

6. The apparatus of claim 5, wherein the sensor circuit includes an electromagnetic radiation source located adjacent a first side of the encoder wheel and one or more electromagnetic radiation detectors located adjacent a second side of the encoder wheel.

7. The apparatus of claim 6, wherein the electromagnetic radiation source comprises a light emitting diode and the electromagnetic radiation detectors comprise one or more photodetectors.

8. The apparatus of claim 7, wherein the sensor circuit generates one or more values indicative of a distance between a first side of the compartment and a second side of the compartment based on light detected by the photodetectors over a period of time.

9. The apparatus of claim 3, wherein the detectable elements comprise machine-detectable marks positioned at radial locations about a circumference of the encoder wheel.

10. The apparatus of claim 5, wherein the sensor circuit includes a light source located adjacent a first side of the encoder wheel and one or more photodetectors located adjacent the first side of the encoder wheel to detect reflected light off the machine-detectable marks.

11. The apparatus of claim 1, wherein the sensor circuit further comprises a pressure sensor and a temperature sensor.

12. The apparatus of claim 1, wherein the reel assembly includes an encoder wheel having detectable elements that are sensed by the sensor circuit.

13. The apparatus of claim 12, wherein the detectable elements are selected from the group consisting of: slit, holes, machine-detectable markings, magnetic elements and mechanical elements.

14. The apparatus of claim 1, wherein the cord includes detectable elements that are sensed by the sensor circuit.

15. A suspension structure for a vehicle comprising:
an air compartment including first and second sides that can move relative to one another; and
means for determining a distance between the first and second sides, the means being housed within the compartment.

16. The suspension structure of claim 15, wherein the means for determining includes a cord and a reel assembly.

17. The suspension structure of claim 16, wherein the means for determining further includes a sensor circuit that detects elements on the reel assembly.

18. A system comprising:
a suspension structure comprising a compartment, a cord within the compartment, a reel assembly that winds the cord as the height of the compartment decreases, and unwinds the cord as the height of the compartment increases, and a sensor circuit that senses winding and unwinding of the cord to determine a height of the compartment; and
a control circuit that controls a spring constant of the suspension structure based on output of the sensor circuit.

19. The system of claim 18, wherein the reel assembly includes a spring-loaded shaft to wind the cord and an encoder wheel that rotates with the shaft, the encoder wheel including the detectable elements.

20. The system of claim 19, wherein the reel assembly further includes a reel assembly housing to house the spring-loaded shaft and encoder wheel, the reel assembly housing defining a hole through which the cord passes.

21. The system of claim 19, wherein the detectable elements comprise slits positioned at radial locations about a circumference of the encoder wheel.

22. The system of claim 19, wherein the sensor circuit includes a light source located adjacent a first side of the encoder wheel and one or more photodetectors located adjacent a second side of the encoder wheel.

23. The system of claim 22, wherein the sensor circuit generates one or more values indicative of a distance between a first side of the compartment and a second side of the compartment based on light detected by the photodetectors over a period of time and outputs the one or more values to the control circuit.

24. The system of claim 18, wherein the detectable elements comprise machine-detectable marks positioned at radial locations about a circumference of the encoder wheel, and wherein the sensor circuit includes a light source located adjacent a first side of the encoder wheel and one or more photodetectors located adjacent the first side of the encoder wheel to detect reflected light off the machine-detectable marks.

25. The system of claim 18, wherein the sensor circuit further comprises a pressure sensor and a temperature sensor.

26. The system of claim 25, wherein the control circuit regulates pressure inside the compartment based on values of height, pressure and temperature.

27. The system of claim 25, further comprising a display coupled to the sensor circuit to display values of height, pressure, and temperature measured inside the compartment by the sensor circuit.

28. The system of claim 18, further comprising a compressor and a regulator that cause input of fluid into the compartment at the direction of the control circuit.

29. A vehicle comprising:
a vehicle frame;
an axle mechanically connected to the vehicle frame via one or more suspension structures, wherein at least one of the suspension structures includes a compartment, a cord within the compartment, a reel assembly that winds the cord as the height of the compartment decreases, and unwinds the cord as the height of the compartment increases, and a sensor circuit that senses winding and unwinding of the cord to determine a height of the compartment.

30. The vehicle of claim 29, further comprising wheels mechanically connected to the axle and an engine to cause motion of the wheels.

31. The vehicle of claim 29, wherein the reel assembly includes a spring-loaded shaft to wind the cord and an encoder wheel that rotates with the shaft, the encoder wheel including the detectable elements.

32. The vehicle of claim 31, wherein the reel assembly further includes a reel assembly housing to house the spring-loaded shaft and encoder wheel, the reel assembly housing defining a hole through which the cord passes.

33. The vehicle of claim 31, wherein the detectable elements comprise slits positioned at radial locations about a circumference of the encoder wheel.

34. The vehicle of claim 31, wherein the sensor circuit includes a light source located adjacent a first side of the encoder wheel and one or more photodetectors located adjacent a second side of the encoder wheel.

35. The vehicle of claim 34, wherein the sensor circuit generates one or more values indicative of a distance between a first side of the compartment and a second side of the compartment based on light detected by the photodetectors over a period of time, and outputs the one or more values to a control circuit, wherein the control circuit adjusts pressure inside the compartment based on the output of the sensor circuit.

36. The vehicle of claim 29, wherein the detectable elements comprise machine-detectable marks positioned at radial locations about a circumference of the encoder wheel, and wherein the sensor circuit includes a light source located adjacent a first side of the encoder wheel and one or more photodetectors located adjacent the first side of the encoder wheel to detect reflected light off the machine-detectable marks.

37. The vehicle of claim 29, wherein the sensor circuit further comprises a pressure sensor and a temperature sensor.

38. The vehicle of claim 37, further comprising a display coupled to the sensor circuit to display values of height, pressure, and temperature measured inside the compartment by the sensor circuit.

39. The vehicle of claim 29, further comprising a regulator to adjust pressure inside the compartment based on an output of the sensor circuit.

40. A method comprising:
internally determining a distance between a first side of a suspension structure and a second side of a suspension structure by sensing winding and unwinding of a cord about a reel assembly; and
adjusting a spring constant associated with the suspension structure based on the determined distance.

41. The method of claim 40, wherein internally determining the distance includes detecting rotation of a spring loaded reel assembly attached to the first side, the spring loaded reel assembly being wound with a cord attached to the second side.

42. The method of claim 41, wherein detecting rotation of a spring loaded reel assembly includes detecting elements of an encoder wheel of the reel assembly.

43. The method of claim 40, further comprising automatically adjusting a spring constant associated with the suspension structure based on the determined distance.

44. The method of claim 40, further comprising:
displaying the determined distance; and
adjusting a spring constant according to user input.

45. A system comprising:
a suspension structure comprising a compartment, a cord within the compartment, a reel assembly that winds the cord as the height of the compartment decreases, and unwinds the cord as the height of the compartment increases, and a sensor circuit that senses winding and unwinding of the cord to determine a height of the compartment; and
a control circuit that displays values indicative of output of the sensor circuit.

46. An apparatus comprising:
a compartment;
a cord within the compartment;
a reel assembly that winds the cord as the height of the compartment decreases, and unwinds the cord as the height of the compartment increases, wherein the real assembly includes a magnet and threading, the threading engaging another threading such that the magnet of the reel assembly moves laterally as the cord winds or unwinds; and
a sensor circuit that senses positioning of the magnet to determine a height of the compartment.

47. A suspension structure comprising:
a compartment defining a sprung side and an non-sprung side;
a cord within the compartment;
a reel assembly attached to the sprung side of the compartment that winds the cord as the height of the compartment decreases, and unwinds the cord as the height of the compartment increases; and
a sensor circuit that determines a height of the compartment based on the winding and unwinding of the cord.

48. A method comprising:
internally determining a distance between a first side of a suspension structure and a second side of a suspension structure by sensing lateral motion of a magnet caused by winding and unwinding of a cord about a reel assembly; and
adjusting a spring constant associated with the suspension structure based on the determined distance.

49. A suspension structure comprising:
a compartment;
a cord within the compartment;
a reel assembly including a magnet, the reel assembly being attached to the suspension structure inside the compartment to wind the cord as a height of the compartment decreases, and unwind the cord as the height of the compartment increases, wherein winding and unwinding of the cord causes reel assembly to move about a threading and thereby cause movement of the magnet; and
a sensor circuit that determines a height of the compartment based on a position of the magnet.

50. A suspension structure comprising:
a compartment;
a cord within the compartment;
a spool including a magnet, the spool being spooled on a threading, wherein the cord is attached to the spool such that when a height of the compartment changes the spool rotates about the threading; and
a sensor circuit that determines a height of the compartment based on a position of the magnet.
